(19) United States
(12) Patent Application Publication
(10) Pub. No.: US 2017/0077510 A1
(43) Pub. Date: Mar. 16, 2017

(54) ELECTRODE, NONAQUEOUS ELECTROLYTE BATTERY, BATTERY PACK AND VEHICLE

(71) Applicant: KABUSHIKI KAISHA TOSHIBA, Minato-ku (JP)

(72) Inventors: Wen Zhang, Sagamihara (JP); Keigo Hoshina, Kashiwazaki (JP); Yasuhiro Harada, Isehara (JP); Takuya Iwasaki, Uenohara (JP); Norio Takami, Yokohama (JP)

(73) Assignee: KABUSHIKI KAISHA TOSHIBA, Minato-ku (JP)

(21) Appl. No.: 15/262,227

(22) Filed: Sep. 12, 2016

(30) Foreign Application Priority Data
Sep. 14, 2015 (JP) 2015-180368

(51) Int. Cl. H01M 4/485; H01M 2/34; H01M 2/10; H01M 10/48; H01M 4/131; H01M 10/44

(52) U.S. Cl. CPC H01M 4/485; H01M 4/131; H01M 10/44; H01M 2/1077; H01M 10/486; H01M 2/348; H01M 2220/20

(57) ABSTRACT

According to one embodiment, an electrode is provided. The electrode includes an active material. A surface composition ratio (Li+C+O)/P of the electrode, which is obtained by measurement using an X-ray photoelectron spectroscopy (XPS), is within a range of 2 to 14.

### CROSS-REFERENCE TO RELATED APPLICATION

This application is based upon and claims the benefit of priority from Japanese Patent Application No. 2015-180368, filed Sep. 14, 2015; the entire contents of which are incorporated herein by reference.

### FIELD

Embodiments described herein relate generally to an electrode, nonaqueous electrolyte battery, battery pack, and vehicle.

### BACKGROUND

Recently, a nonaqueous electrolyte battery such as a lithium ion secondary battery has been developed as a high energy-density battery. The nonaqueous electrolyte battery is anticipated as a power source for vehicles such as hybrid automobiles and electric cars. The nonaqueous electrolyte battery is also anticipated as an uninterruptible power supply for base stations for portable telephone. Therefore, the nonaqueous electrolyte battery is demanded to have other good performances such as rapid charge-and-discharge performances and long-term reliability, as well. A nonaqueous electrolyte battery capable of rapid charge and discharge has the benefit that charging time is remarkably short, and is able to improve motive performances in hybrid automobiles. Furthermore, the battery can also efficiently recover regenerative energy from power of the vehicle.

Rapid charge-and-discharge becomes possible by rapid migration of electrons and lithium ions between the positive electrode and the negative electrode. However, when a battery using a carbon-based negative electrode is repeatedly subjected to rapid charge-and-discharge, dendrite of metallic lithium may sometimes precipitate on the electrode. Dendrites cause internal short circuits, and as a result raise concern that heat generation and/or fires may occur

In light of this, a battery using a metal composite oxide as a negative electrode active material in place of a carbonaceous material has been developed. In particular, in a battery using titanium oxide as the negative electrode active material, rapid charge-and-discharge can be stably performed. Such a battery also has a longer life than those using a negative electrode with carbonaceous material.

However, compared to carbonaceous materials, oxides of titanium have a higher potential (is more noble) relative to metallic lithium. Furthermore, oxides of titanium have a lower capacity per weight. Therefore, a battery using an oxide of titanium as the negative electrode active material has a problem that the energy density is lower.

For example, the potential of the electrode using an oxide of titanium is about 1.5 V relative to metallic lithium and is higher (more noble) than that of the negative electrode with carbonaceous material. The potential of an oxide of titanium arises from the redox reaction between Ti³⁺ and Ti⁴⁺ upon electrochemical insertion and extraction of lithium, and is therefore electrochemically limited. There also is the fact that at a high charge potential of about 1.5 V, rapid charge-and-discharge of lithium ions can be performed stably. In the case that the charge potential is lowered, there is concern that rapid charge-and-discharge cannot be performed stably. It is therefore practically difficult to drop the potential of the electrode in order to improve the energy density.

On the other hand, considering the capacity per unit weight, the theoretical capacity of lithium titanate (anatase structure) is about 165 mAh/g, and the theoretical capacity of a lithium-titanium composite oxide such as Li₄Ti₅O₁₂ is about 180 mAh/g. On the other hand, the theoretical capacity of a general graphite based electrode material is 385 mAh/g and greater. Therefore, the capacity density of an oxide of titanium is significantly lower than that of the carbon based negative electrode. This is due to there being only a small number of lithium-insertion sites in the crystal structure, and lithium tending to be stabilized in the structure, and thus, substantial capacity being reduced.

In view of such circumstances, a new electrode material including titanium (Ti) and niobium (Nb) has been examined. Such materials are expected to have high charge-and-discharge capacities. In particular, a composite oxide represented by TINb₂O₇ has a theoretical capacity exceeding 380 mAh/g; however, the substantial capacity of an electrode of TiNb₂O₇ is about low as 260 mAh/g, and has the problem that the charge-and-discharge life is short.

### BRIEF DESCRIPTION OF THE DRAWINGS

FIG. 1 is a schematic view showing a crystal structure of monoclinic TiNb₂O₇;

FIG. 2 is a schematic view showing the crystal structure of FIG. 1 viewed from another direction;

FIG. 3 is a cross-sectional view of a flat-form nonaqueous electrolyte battery according to a second embodiment;

FIG. 4 is an enlarged cross-sectional view showing a portion A in FIG. 3;

FIG. 5 is a partially cut-out perspective view schematically showing another flat-form nonaqueous electrolyte battery according to the second embodiment;

FIG. 6 is an enlarged cross-sectional view showing a portion B in FIG. 5;

FIG. 7 is an exploded perspective view showing a battery pack according to a third embodiment;

FIG. 8 is a block diagram showing an electric circuit of the battery pack of FIG. 7;

FIG. 9 is a graph showing a charge-and-discharge curve of an example of a measurement cell according to an embodiment;

FIG. 10 is a graph showing a rate performance of an example of a measurement cell for measurement according to an embodiment;

FIG. 11 is another graph showing a rate performance of an example of a measurement cell for measurement according to an embodiment;

FIG. 12 is a graph showing a capacity variation per cycle of an example of a measurement cell according to an embodiment;

FIG. 13 is a graph showing a capacity variation per cycle of an example of a laminate cell according to an embodiment;

FIG. 14 is a graph showing a variation in a coulomb efficiency per cycle of an example of a laminate cell according to an embodiment;

FIG. 15 is a graph showing a capacity variation per cycle of an example of another laminate cell according to the embodiment;

FIG. 16 is a graph showing a variation in a coulomb efficiency per cycle of an example of another laminate cell according to the embodiment; and

FIG. 17 is a schematic view showing a vehicle including the battery pack according to the third embodiment.

### DETAILED DESCRIPTION

According to one embodiment, an electrode is provided. The electrode includes an active material. A surface composition ratio (Li+C+O)/P of the electrode, which is obtained by measurement using an X-ray photoelectron spectroscopy (XPS), is within a range of 2 to 14.

According to another embodiment, a nonaqueous electrolyte battery including a negative electrode, a positive electrode, a separator, and a nonaqueous electrolyte is provided. At least one of the negative electrode and the positive electrode, included in the nonaqueous electrolyte battery, is the electrode of the embodiment described above.

According to yet another embodiment, a battery pack including the nonaqueous electrolyte battery described above is provided.

According to still another embodiment, provided is a vehicle onto which the battery pack described above is mounted.

### First Embodiment

An electrode according to a first embodiment includes an active material, and a surface composition ratio (Li+C+O)/P of the electrode, which is obtained by measurement using an X-ray photoelectron spectroscopy (XPS), is within a range of 2 to 14. The active material included in the electrode according to the embodiment may include, for example a niobium-titanium composite oxide.

The embodiment is explained below with reference to the drawings.

In the electrode according to the embodiment, the surface composition ratio (Li+C+O)/P, which is obtained by measurement using an X-ray photoelectron spectroscopy (XPS), is within a range of 2 to 14. The surface composition ratio (Li+C+O)/P represents a ratio of the total number of lithium atoms (Li), carbon atoms (C), and oxygen atoms (O) to the number of phosphorus atoms (P) on the electrode surface. The surface composition ratio can be obtained by subjecting the electrode to the XPS measurement. The XPS measurement will be described in detail later.

The electrode having a surface composition ratio (Li+C+O)/P of 2 to 14 may have, for example a coating film on the electrode surface. The coating film may include a reaction product including phosphorus (P) and oxygen (O).

The electrode having a surface composition ratio (Li+C+O)/P of 2 to 14 can be used, for example, as a negative electrode or a positive electrode in a nonaqueous electrolyte battery. In the nonaqueous electrolyte battery including the electrode, the life performance is improved. In addition, the nonaqueous electrolyte battery including the electrode may show good life performance in charge-and-discharge cycles at a low charge potential. Therefore, when the electrode of the embodiment is used, the energy density of the nonaqueous electrolyte battery can be improved while the life performance is maintained.

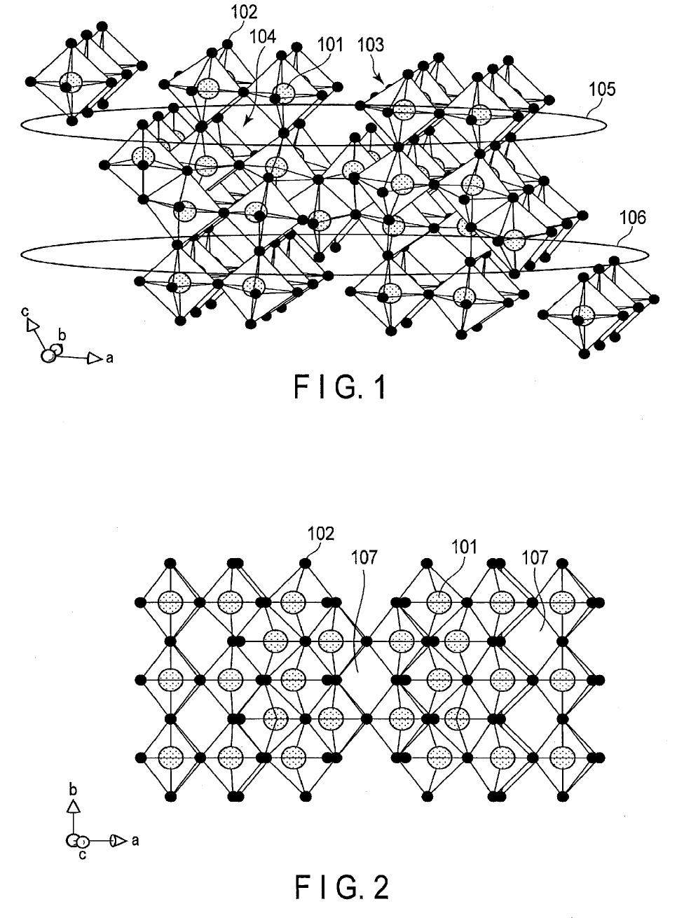

The active material included in the electrode may include, for example, a niobium-titanium composite oxide. The niobium-titanium composite oxide mainly exhibits a monoclinic crystal structure. As an example thereof, schematic views showing a crystal structure of monoclinic TiNb₂O₇ are shown in FIGS. 1 and 2.

As shown in FIG. 1, in the crystal structure of monoclinic TiNb₂O₇, metal ions 101 and oxide ions 102 form a structural framework 103. In the metal ion 101, Nb ions and Ti ions are randomly arranged at a ratio of Nb:Ti=2:1. When the structural frameworks 103 are alternately arranged three-dimensionally, vacancies 104 exist among the structural frameworks 103. The vacancies 104 serve as a host for lithium ions.

In FIG. 1, a region 105 and region 106 are portions having two-dimensional channels in a [001] direction and a [010] direction. For each, as shown in FIG. 2, in the crystal structure of monoclinic TiNb₂O₇, vacancies 107 exist in a [001] direction. The space 107 has a tunnel structure advantageous for electrical conduction of lithium ions, and serves as a conductive path in the [001] direction connecting the region 105 to the region 106. The lithium ions can migrate between the region 105 and the region 106 due to the presence of the conductive path.

As described above, in the monoclinic crystal structure, insertion spaces for the lithium ions of equivalent valence are large and structurally stable. In addition, due to the presence of the regions having the two-dimensional channel in which the lithium ions rapidly diffuse, and the conductive paths in the [001] direction connecting these regions, the insertion and extraction property of the lithium ion into and from the insertion space is improved, and the insertion and extraction space of the lithium ions is effectively increased. As a result, it is possible to provide high capacity and high rate performance.

For the niobium-titanium composite oxide, which can be included in the active material of the electrode of the embodiment, although not limited thereto, it is preferable to have C2/m space group symmetry, and to have a crystal structure having an atomic coordinate described in “Journal of Solid State Chemistry 53, pp 144-147 (1984).”

Further, in the crystal structure described above, when lithium ions are inserted into vacancies 104, the metal ions 101 forming the framework are reduced to trivalent, whereby the crystals are maintained to be electrically neutral. In the niobium-titanium composite oxide, which can be included in the electrode of the embodiment, not only are Ti ions reduced from tetravalent to trivalent, but Nb ions are reduced from pentavalent to trivalent, also. Thus, a reduction valence per weight of the active material is large. For that reason, even if a large amount of lithium ions is inserted, it is possible to maintain the crystal to be electrically neutral. Thus, the composite oxide has higher energy density compared to compounds such as titanium oxide, which only have tetravalent cations. Such a niobium-titanium composite oxide has a theoretical capacity of about 387 mAh/g, which is twice or more that of an oxide of titanium having a spinel structure.

In addition, the niobium-titanium composite oxide has a lithium insertion potential of about 1.5 V (vs. Li/Li⁺). Thus, use of the active material contributes to providing a battery capable of a stable repetitive rapid charge-and-discharge.

From the above, by including the active material that includes the niobium-titanium composite oxide, it is possible to provide an electrode for a battery having more excellent rapid charge-and-discharge performance and energy density that is higher further.

The niobium-titanium composite oxide is preferably a composite oxide represented by LiₓTiNb_{2-y}M_{y}O_{7±δ}, wherein 0≦x≦5, 0≦y≦0.5, and 0≦δ≦0.3. Here, element M is at least one selected from the group consisting of B, Na, Mg, Al, Si, S, P, K, Ca, Mo, W, Cr, Mn, Co, Ni and Fe. Element M may be one of these elements or a combination of two or more of these elements. The composite oxide represented by LiₓTiNb_{2-y}M_{y}O_{7±δ} has, for each chemical formula, one cation capable of being reduced from tetravalent to trivalent and at most two cations capable of being reduced from pentavalent to trivalent. Thus, at most 5 lithium ions can be theoretically inserted into the composite oxide. Accordingly, x is 0 to 5 in the chemical formula described above. When the element M included in the active material exists in a state in which they all substitute Nb atoms to be solid solubilized in a crystal lattice of the niobium-titanium composite oxide, y=0.5. On the other hand, when the element M included in the active material does not exist uniformly in the crystal lattice, but exists unevenly and/or is segregated in the crystal lattice, y=0. The value δ varies depending on the reduction state of the monoclinic niobium-titanium composite oxide. When δ is more than −0.3, the niobium becomes reduced prematurely, thus resulting in decreased electrode performance, and furthermore a phase separation may occur. On the other hand, a range up to δ=+0.3 is within measurement error.

The composite oxide represented by LiₓTiNb_{2-y}M_{y}O_{7γδ} where 0≦x≦5, 0≦y≦0.5, and 0≦δ≦0.3 is preferable, because even if a part of the niobium atoms are substituted by the element M, which form a solid solution, the capacity does not substantially decrease. The composite oxide is preferable also because improvement of electronic conductivity by substitution with a dopant can be expected.

Further, the niobium-titanium composite oxide, which may be included in the active material that is included in the electrode of the embodiment, preferably has a melting point of 1350° C. or lower, and more preferably has a melting point of 1250° C. or lower. In the niobium-titanium composite oxide having a melting point of 1350° C. or lower, high crystallinity can be obtained even if a calcining temperature is low. Thus, the composite oxide can be synthesized by utilizing existing facilities. Since the composite oxide can be synthesized at a low calcining temperature, the composite oxide has the advantage of high productivity.

Further, in the niobium-titanium composite oxide, a coating film or a reaction product is formed on the surface of the active material due to a reaction with an electrolytic solution. For example, when LiPF₆ is used as an electrolyte included in the electrolytic solution, a product including phosphorus (P) and oxygen (O) is formed. The surface composition ratio of the active material may vary due to the formation of such a product on the surface of the active material. When the surface composition ratio (Li+C+O)/P is within a range of 2 to 14, the lifetime of the niobium-titanium composite oxide is improved.

For example, by forming in advance, a coating film having a composition ratio (Li+C+0)/P of 2 to 14 on the surface of the active material including the niobium-titanium composite oxide, the lifetime of a nonaqueous electrolyte battery, in which the niobium-titanium composite oxide is used as the negative electrode, can be improved. Such a coating film can be formed on the surface of the active material, for example by using a compound including phosphorus such as lithium phosphate.

<Method of Producing Electrode>

The electrode having a surface composition ratio (Li+C+O)/P of 2 to 14 can be produced, for example by using an active material including active material particles having a coating film including lithium (Li), phosphorus (P), or oxygen (O). The active material particles having the coating film including lithium, phosphorus, or oxygen can be produced in the following manner.

In one example, first, 0.5% by weight to 10% by weight, relative to an active material, of lithium phosphate (Li₃PO₄) is added to the active material, and then mixed. After the active material to which the lithium phosphate is added is thoroughly mixed, the resulting active material is calcined at a temperature of 400° C. to 800° C. in the air, under an inert atmosphere such as argon (Ar) gas atmosphere, or under a reducing atmosphere, whereby a coating film including lithium, phosphorus, or oxygen is formed on the surface of the active material particles.

In another example, first, 0.5% by weight to 10% by weight, relative to an active material, of lithium phosphate (Li₃PO₄) is dissolved in a solvent such as water to obtain a solution. The active material particles are added to this solution, and the mixture is stirred. After the solvent to which the active material particles are added is thoroughly stirred, the solvent is evaporated at a temperature of about 100° C., and the obtained active material particles are calcined. The calcining is performed under conditions of a temperature of 400° C. to 800° C. in the air, under an inert atmosphere such as argon (Ar) gas atmosphere, or under a reducing atmosphere.

Alternatively, in a cell that includes an electrode including an active material and an electrolytic solution, an appropriate additive is added to the electrolytic solution, and the resulting cell is charged and discharged, whereby a coating film including lithium, phosphorus, or oxygen can be formed on the surface of the active material. The electrolytic solution includes, for example lithium hexafluorophosphate (LiPF₆) as the electrolyte. The additive includes, for example, tris(trimethylsilyl)phosphate (TMSP), lithium difluoro phosphate (LiPF₂O₂), or a mixture with another additive. These additives can be favorably used as an appropriate additive, for example, when the niobium-titanium composite oxide is used as the active material. The charge-and-discharge of the cell is performed, for example, within a range in which the negative electrode potential is from 0.4 V to 3 V (vs. Li/Li⁺).

<Method of Producing Niobium-Titanium Composite Oxide>

The niobium-titanium composite oxide, which can be included in the active material in the electrode, can be produced by the following method.

First, starting materials are mixed. As the starting material for the niobium-titanium composite oxide, oxides or salts including Li, Ti, and Nb are used. As a starting material for the element M, an oxide or a salt including at least one element selected from the group consisting of B, Na, Mg, Al, Si, S, P, K, Ca, Mo, W, Cr, Mn, Co, Ni, and Fe is used. The oxide may include one of these elements, or the oxide may include two or more of these elements. For example, when LiₓTiNb_{2-y}(Mo_{0.75y}Mg_{0.25y})O_{7+δ} is synthesized, MgO, and MoO₂ or MoO₃ can be used as the starting material. The salt used as the starting material is preferably a salt capable of producing an oxide by decomposition at a relatively low temperature, such as a carbonate or nitrate.

The starting materials are mixed in proportions such that a molar ratio (M/Ti) would be 0.5 or less (excluding 0). It is preferable to mix the starting materials in a molar ratio in which all electric charges of a crystal where a part of Nb atoms are substituted by the element M would be maintained to be neutral. Thereby, a crystal can be obtained, in which the crystal structure of LiₓTiNb₂O₇ is maintained. On the other hand, even with a method of adding the element M in which all the electric charge would not be maintained to be neutral, by adjusting the amount of the element M added, a crystal can be obtained where the crystal structure of LiₓTiNb₂O₇ is maintained at most portions.

Next, the obtained mixture is pulverized to obtain a mixture which is as uniform as possible. Subsequently, the obtained mixture is calcined. The calcining is performed at a temperature range of 500° C. to 1200° C. for 10 hours to 40 hours in total. According to the present embodiment, it is possible to obtain a composite oxide having the high crystallinity even at a temperature of 1200° C. or lower. The calcining is more preferably performed at a temperature range of 800° C. to 1000° C. When the calcining temperature is 1000° C. or lower, existing facilities can be utilized.

According to the method described above, the niobium-titanium composite oxide represented by LiₓTiNb_{2-y}M_{y}O_{7±δ} where 0≦x≦5, 0≦y≦0.5, and 0≦δ≦0.3 can be obtained.

Lithium ions may be inserted into the niobium-titanium composite oxide synthesized by the method described above, by charging a battery including the composite oxide. Alternatively, the composite oxide may be synthesized as a composite oxide including lithium by using as starting material a compound including lithium such as lithium carbonate.

<X-Ray Photoelectron Spectroscopy (XPS)>

The quantitative analysis of the electrode surface can be performed through measurement by X-ray photoelectron spectroscopy (XPS). In the XPS measurement, for example, a combined electron spectrometer can be used. In the measurement, for example a 300 W monochromated-Al-Kα radiation (1486.6 eV) can be used as an X-ray source. A photoelectron take-off angle is adjusted to 45° (depth of measurement: about 4 nm). A measurement area is set to be an elliptical shape having Φ 800 μm (long axis).

In the XPS measurement of the electrode, the active material, the conductive agent, and the binder, which are included in the electrode, may be measured. In particular, the active material, the conductive agent, and the binder that are exposed on the electrode surface may be measured. By performing the XPS measurement on the electrode, the element stability on the electrode surface can be examined, and quantitative analysis and condition analysis of the electrode surface can be performed. For example, first, for the electrode surface, a peak intensity of Li (1s) peak corresponding to lithium, a peak intensity of C (1s) peak corresponding to carbon, a peak intensity of O (1s) peak corresponding to oxygen, and a peak intensity of P (2p) peak corresponding to phosphorus are measured by XPS. From a peak intensity ratio of these peaks, an abundance ratio of lithium (Li), carbon (C), oxygen (O), and phosphorus (P) on the electrode surface can be obtained. From the thus obtained analysis results of the electrode surface, the surface composition ratio (Li+C+O)/P of the electrode can be calculated.

For an electrode after being charged and discharged, the electrode in a discharged state is taken out from, for example a battery cell to be subjected to XPS measurement. For example, first, the battery cell after being discharged is disassembled under an inert atmosphere such as an argon (Ar) atmosphere. The electrode is taken out from the disassembled battery cell, and washed. For example, the electrode taken out is promptly immersed in an ethylmethyl carbonate solvent, and is washed by gently rocking for about 10 minutes. Next, the washed electrode is dried under a vacuum atmosphere for 30 minutes or more to completely remove the solvent. The dried electrode is introduced into an XPS analyzer without exposing it to air, and the XPS measurement is performed.

In the electrode according to the first embodiment, a surface composition ratio of the electrode, as obtained by the measurement using the X-ray photoelectron spectroscopy (XPS), satisfies 2≦(Li+C+O)/P≦14. The electrode has excellent rapid charge-and-discharge performance and high energy density, and exhibits good life performance.

### Second Embodiment

A nonaqueous electrolyte battery according to a second embodiment includes a negative electrode, a positive electrode, a separator, and a nonaqueous electrolyte. The negative electrode included in the nonaqueous electrolyte battery of the present embodiment is the electrode according to the first embodiment.

The negative electrode, the positive electrode, the nonaqueous electrolyte, the separator, and a container member, which can be included in the nonaqueous electrolyte battery according to the embodiment, are explained in detailed below.

1) Negative Electrode

The negative electrode includes a current collector, and a negative electrode layer (i.e., a negative electrode active material-including layer). The negative electrode layer is formed on one surface or both of reverse surfaces of the current collector, and includes an active material, and optionally a conductive agent and a binder. The surface composition ratio (Li+C+O)/P of the negative electrode, obtained by the measurement using the X-ray photoelectron spectroscopy (XPS), is within a range of 2 to 14.

As a negative electrode active material, for example the active material including the niobium-titanium composite oxide described above can be used. Thereby, it is possible to provide a battery excellent in productivity, and having excellent rapid charge-and-discharge performance and high energy density.

As the negative electrode active material, the above described active material may be singly used; however, other active materials may be used in combination. Examples of other active materials include titanium dioxide having an anatase structure (TiO₂), lithium titanate having a ramsdellite structure (e.g., Li₂Ti₃O₇), and lithium titanate having a spinel structure (e.g., Li₄Ti₅O₁₂). One of these other active materials may be used in combination with the above described active material including the niobium-titanium composite oxide. Alternatively, two or more of these other active materials may be used in combination with the above described active material including the niobium-titanium composite oxide.

The conductive agent is added to improve a current collection performance and to suppress the contact resistance between the active material and the current collector. Examples of the conductive agent include carbonaceous substances such as acetylene black, carbon black, and graphite. In addition, known conductive agents such as vapor grown carbon fiber (VGCF) (registered trademark by Showa Denko). One of these may be used as the conductive agent, or two or more may be used in combination as the conductive agent.

The binder is added to fill gaps among the dispersed negative electrode active material and also to bind the active material with the current collector. Examples of the binder include polytetrafluoroethylene (PTFE), polyvinylidene fluoride (PVdF), fluorine rubber, and styrene-butadiene rubber. One of these may be used as the binder, or two or more may be used in combination as the binder.

The active material, conductive agent and binder in the negative electrode layer are preferably blended in proportions of 68% by mass to 96% by mass, 2% by mass to 30% by mass, and 2% by mass to 30% by mass, respectively. When the amount of conductive agent is 2% by mass or more, the current collection performance of the negative electrode layer can be improved. When the amount of binder is 2% by mass or more, binding between the negative electrode layer and current collector becomes sufficient, and excellent cycling performances can be expected. On the other hand, an amount of each of the conductive agent and binder is preferably 28% by mass or less, in attempting to increase the capacity.

As the current collector, a material which is electrochemically stable at the lithium insertion and extraction potential of the negative electrode active material is used. The current collector is preferably made of copper, nickel, stainless steel or aluminum, or an aluminum alloy including one or more elements selected from Mg, Ti, Zn, Mn, Fe, Cu, and Si. The thickness of the current collector is preferably 5 μm to 20 μm. The current collector having such a thickness can maintain balance between the strength and weight reduction of the negative electrode.

The negative electrode is produced by, for example, suspending a negative electrode active material, a binder, and a conductive agent in an ordinarily used solvent to prepare a slurry, applying the slurry to a current collector, drying the coating to form a negative electrode layer, and then pressing the layer. Alternatively, the negative electrode may also be produced by forming a negative electrode active material, a binder, and a conductive agent into pellets as the negative electrode layer, and disposing the pellets onto a current collector.

2) Positive Electrode

The positive electrode includes a current collector and a positive electrode layer (i.e., a positive electrode active material-including layer). The positive electrode layer is formed on one surface or both of reverse surfaces of the current collector. The positive electrode layer includes a positive electrode active material, and optionally a conductive agent and a binder.

As the positive electrode active material, for example, an oxide or a sulfide may be used. Examples of the oxide and sulfide include manganese dioxide (MnO₂), iron oxide, copper oxide, nickel oxide, lithium manganese composite oxide (e.g., LiₓMn₂O₄ or LiₓMnO₂), lithium nickel composite oxide (e.g., LiₓNiO₂), lithium cobalt composite oxide (e.g., LixCoO₂), lithium nickel cobalt composite oxide (e.g., LiNi_{1-y}Co_{y}O₂), lithium manganese cobalt composite oxide (e.g., LiₓMn_{y}Co_{1-y}O₂), lithium manganese nickel composite oxide having a spinel structure (e.g., LiₓMn_{2-y}Ni_{y}O₄) lithium phosphorus oxide having an olivine structure (e.g., LiₓFePO₄, LiₓFe_{1-y}Mn_{y}PO₄, and LiₓCoPO₄), iron sulfate [Fe₂(SO₄)₃], vanadium oxide (e.g., V₂O₅), and lithium nickel cobalt manganese composite oxide, to which lithium can be inserted. In the above-described formulas, 0<x≦1, and 0<y≦1. As the active material, one of these compounds may be used singly, or plural compounds may be used in combination.

More preferred examples of the active material include lithium manganese composite oxide (e.g., LiₓMn₂O₄), lithium nickel composite oxide (e.g., LiₓNiO₂), lithium cobalt composite oxide (e.g., LiₓCo_{y}O₂), lithium nickel cobalt composite oxide (e.g., LiNi_{1-y}Co_{y}O₂), lithium manganese nickel composite oxide having a spinel structure (e.g., LiₓMn_{2-y}Ni_{y}O₄), lithium manganese cobalt composite oxide (e.g., LiₓMn_{y}Co_{1-y}O₂), lithium iron phosphate (e.g., LiₓFePO₄), and lithium nickel cobalt manganese composite oxide, which have a high positive electrode voltage. In the above-described formulas, 0<x≦1, and 0<y≦1.

When an ordinary temperature molten salt is used as the nonaqueous electrolyte of the battery, preferred examples of the active material include lithium iron phosphate, LiₓNPO₄F (0≦x≦1), lithium manganese composite oxide, lithium nickel composite oxide, and lithium nickel cobalt composite oxide. Since these compounds have low reactivity with ordinary temperature molten salts, cycle life can be improved.

The primary particle size of the positive active material is preferably 100 nm to 1 μm. The positive electrode active material having a primary particle size of 100 nm or more is easy to handle during industrial production. In the positive electrode active material having a primary particle size of 1 μm or less, diffusion of lithium ions within solid can proceed smoothly.

The specific surface area of the positive electrode active material is preferably 0.1 m²/g to 10 m²/g. The positive electrode active material having a specific surface area of 0.1 m²/g or more can secure sufficient sites for inserting and extracting lithium ions. The positive electrode active material having a specific surface area of 10 m²/g or less is easy to handle during industrial production, and can secure a good charge-and-discharge cycle performance.

The binder is added to bind the active material with the current collector. Examples of the binder include polytetrafluoroethylene (PTFE), polyvinylidene fluoride (PVdF), and fluorine rubber. One of these may be used as the binder, or two or more may be used in combination as the binder.

The conductive agent is added as necessary, in order to improve the current collection performance, and at the same time, suppress the contact resistance between the active material and current collector. Examples of the conductive agent include carbonaceous substances such as acetylene black, carbon black and graphite. One of these may be used as the conductive agent, or two or more may be used in combination as the conductive agent.

In the positive electrode layer, the active material and binder are preferably included in proportions of 80% by mass to 98% by mass, and 2% by mass to 20% by mass, respectively.

When the amount of the binder is 2% by mass or more, sufficient electrode strength can be achieved. When the amount of the binder is 20% by mass or less, the amount of the insulator in the electrode can be reduced, and thereby the internal resistance can be decreased.

When a conductive agent is added, the active material, binder, and conductive agent are preferably included in proportions of 77% by mass to 95% by mass, 2% by mass to 20% by mass, and 3% by mass to 15% by mass, respectively. When the amount of the conductive agent is 3% by mass or more, the above-described effects can be expressed. By setting the amount of the positive electrode conductive agent to 15% by mass or less, the decomposition of a nonaqueous electrolyte on the surface of the positive electrode conductive agent during high-temperature storage can be reduced.

The current collector is preferably an aluminum foil, or an aluminum alloy foil including one or more elements selected from Mg, Ti, Zn, Ni, Cr, Mn, Fe, Cu, and Si.

The thickness of the aluminum foil or aluminum alloy foil is preferably 5 μm to 20 μm, and more preferably 15 μm or less. The purity of the aluminum foil is preferably 99% by mass or more. The amount of the transition metal such as iron, copper, nickel, or chromium included in the aluminum foil or aluminum alloy foil is preferably 1% by mass or less.

The positive electrode is produced by, for example, suspending an active material, a binder, and a conductive agent, which is added as necessary, in an appropriate solvent to prepare a slurry, applying the slurry to a positive electrode current collector, drying the coating to form a positive electrode layer, and then pressing the layer. The positive electrode may also be produced by forming an active material, a binder, and a conductive agent, which is added as necessary, into pellets as the positive electrode layer, and disposing the pellets onto a current collector.

3) Nonaqueous Electrolyte

The nonaqueous electrolyte may be, for example, liquid nonaqueous electrolyte which is prepared by dissolving an electrolyte in an organic solvent, gel like nonaqueous electrolyte which is a composite of a liquid electrolyte and a polymer material, or a solid electrolyte. Note that a liquid nonaqueous electrolyte may be referred to as an electrolytic liquid.

The liquid nonaqueous electrolyte is preferably prepared by dissolving an electrolyte in an organic solvent at a concentration of 0.5 mol/L to 2.5 mol/L.

Examples of the electrolyte include lithium salts such as lithium perchlorate (LiClO₄), lithium hexafluorophosphate (LiPF₆), lithium tetrafluoroborate (LiBF₄), lithium hexafluoroarsenate (LiAsF₆), lithium trifluoromethanesulfonate (LiCF₃SO₃), and lithium bistrifluoromethylsulfonylimide [LiN(CF₃SO₂)₂], and mixtures thereof. The electrolyte is preferably resistant to oxidation even at a high potential, and most preferably LiPF₆.

Examples of the organic solvent include a cyclic carbonate such as propylene carbonate (PC), ethylene carbonate (EC), or vinylene carbonate (VC); a linear carbonate such as diethyl carbonate (DEC), dimethyl carbonate (DMC), or methyl ethyl carbonate (MEC); a cyclic ether such as tetrahydrofuran (THF), 2-methyl tetrahydrofuran (2-MeTHF), or dioxolane (DOX); a linear ether such as dimethoxy ethane (DME) or diethoxy ethane (DEE); γ-butyrolactone (GBL), acetonitrile (AN), and sulfolane (SL). These organic solvents may be used singularly or as a mixed solvent.

Examples of the polymeric material include polyvinylidene fluoride (PVdF), polyacrylonitrile (PAN), and polyethylene oxide (PEO).

Alternatively, the nonaqueous electrolyte may be, for example, an ordinary temperature molten salt (ionic melt) including lithium ions, a polymer solid electrolyte, or an inorganic solid electrolyte.

The ordinary temperature molten salt (ionic melt) means compounds among organic salts made of combinations of organic cations and anions, which are able to exist in a liquid state at ordinary temperature (15° C. to 25° C.). The ordinary temperature molten salt includes an ordinary temperature molten salt which exists alone as a liquid, an ordinary temperature molten salt which becomes a liquid upon mixing with an electrolyte, and an ordinary temperature molten salt which becomes a liquid when dissolved in an organic solvent. In general, the melting point of the ordinary temperature molten salt used in nonaqueous electrolyte batteries is 25° C. or below. The organic cations generally have a quaternary ammonium framework.

The polymer solid electrolyte is prepared by dissolving the electrolyte in a polymeric material, and solidifying it. The inorganic solid electrolyte is a solid substance having lithium ion conductivity.

4) Separator

The separator may be made of, for example, a porous film or synthetic resin nonwoven fabric including polyethylene, polypropylene, cellulose, or polyvinylidene fluoride (PVdF). Among these, a porous film formed of polyethylene or polypropylene melts at a fixed temperature and thus able to shut off a current, therefore the porous film can improve safety.

5) Container Member

As the container member, a laminate film having a thickness of 0.5 mm or less, or a metal case having a wall thickness of 1 mm or less may be used. The thickness of the laminate film is more preferably 0.2 mm or less. The wall thickness of the metal case is more preferably 0.5 mm or less, and still more preferably 0.2 mm or less.

The shape of the container member may be flat (thin), square, cylinder, coin, or button-shaped. The container member depends on the size of the battery, and may be that for a compact battery mounted on mobile electronic devices, or a large battery mounted on vehicles such as two- to four-wheel automobiles.

As the laminate film, used is a multilayer film where a metal layer is sandwiched between resin layers. The metal layer is preferably an aluminum foil or an aluminum alloy foil, so as to reduce weight. The resin layer may be, for example, a polymeric material such as polypropylene (PP), polyethylene (PE), nylon, or polyethylene terephthalate (PET). The laminate film may be heat-sealed to be formed into the shape of a container member.

The metal case is made of aluminum or an aluminum alloy. As the aluminum alloy, an alloy including one or more of an element such as magnesium, zinc, or silicon is preferable. If a transition metal such as iron, copper, nickel, or chromium is included in the alloy, the included amount thereof is preferably set to 100 ppm or less.

6) Nonaqueous Electrolyte Secondary Battery

Next, an example of a battery according to the second embodiment will be specifically described with reference to the drawings.

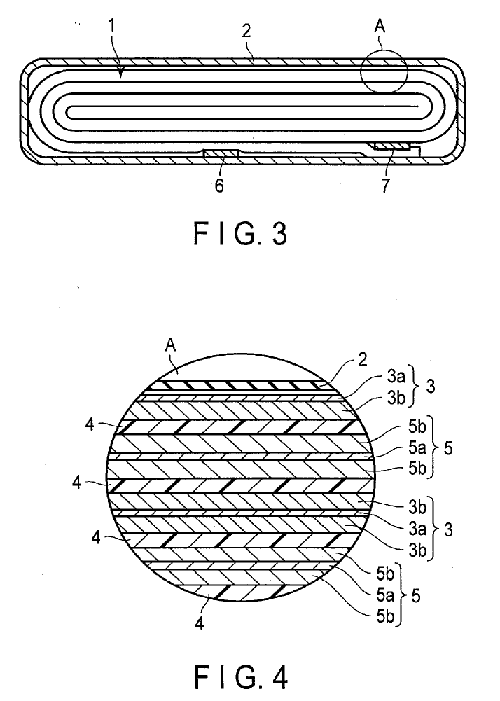

FIG. 3 is a cross-sectional view of a flat-form nonaqueous electrolyte secondary battery. FIG. 4 is an enlarged cross-sectional view showing a portion A in FIG. 3. Each drawing is a typical view for explaining the embodiments and for promoting an understanding of the embodiments. Though there are parts different from an actual device in shape, dimension and ratio, these structural designs may be properly changed taking the following explanations and known technologies into consideration.

An electrode group 1 in flat form is housed in a bag-shaped container member 2. The bag shaped container member 2 is made of a laminate film where a metal layer is sandwiched between two resin layers. The flat-form wound electrode group 1 is formed by, spirally winding a stack where stacked, in order from the outside, are a negative electrode 3, a separator 4, a positive electrode 5, and a separator 4, as shown in FIG. 4, and then press-forming the wound laminate.

The negative electrode 3 includes a negative electrode current collector 3a and a negative electrode layer 3b. The above describe negative electrode active material is included in the negative electrode layer 3b. The negative electrode 3 on the outermost side has a configuration in which a negative electrode layer 3b is formed only on one surface, which is the internal surface of a negative electrode current collector 3a, as shown in FIG. 4. In the other negative electrodes 3, the negative electrode layers 3b are formed on both of reverse surfaces of the negative electrode current collector 3a.

In the positive electrode 5, positive electrode layers 5b are formed on both of reverse surfaces of the positive electrode current collector 5a.

As shown in FIG. 3, in the vicinity of the outer peripheral edge of the wound electrode group 1, a negative electrode terminal 6 is connected to the negative electrode current collector 3a in the outermost negative electrode 3, and a positive electrode terminal 7 is connected to the positive electrode current collector 5a in the positive electrode 5 on the inner side. The negative electrode terminal 6 and the positive electrode terminal 7 are extended out from the opening of the bag shaped container member 2. The liquid-form nonaqueous electrolyte is, for example, inserted from an opening in the bag-shaped container member 2. By heat-sealing the opening in the bag-shaped container member 2, sandwiching the negative electrode terminal 6 and positive electrode terminal 7 therebetween, the wound electrode group 1 and liquid-form nonaqueous electrolyte are completely sealed in.

The negative electrode terminal 6 may be made of a material which is electrochemically stable at the Li insertion and extraction potential, and having electrical conductivity. Specific examples include copper, nickel, stainless steel, or aluminum. The negative electrode terminal 6 is preferably made of the same material as the negative electrode current collector 3a in order to reduce the contact resistance with the negative electrode current collector 3a.

The positive electrode terminal 7 may be formed of, for example, a material which has electrical stability in the potential range of 3 V to 5 V (vs. Li/Li⁺) relative to the oxidation-and-reduction potential of lithium, and electrical conductivity. Specifically, the positive electrode terminal is formed of aluminum or an aluminum alloy including one or more of Mg, Ti, Zn, Mn, Fe, Cu, Si or the like. The positive electrode terminal 7 is preferably formed of the same material as the positive electrode current collector 5a in order to reduce contact resistance with the positive electrode current collector 5a.

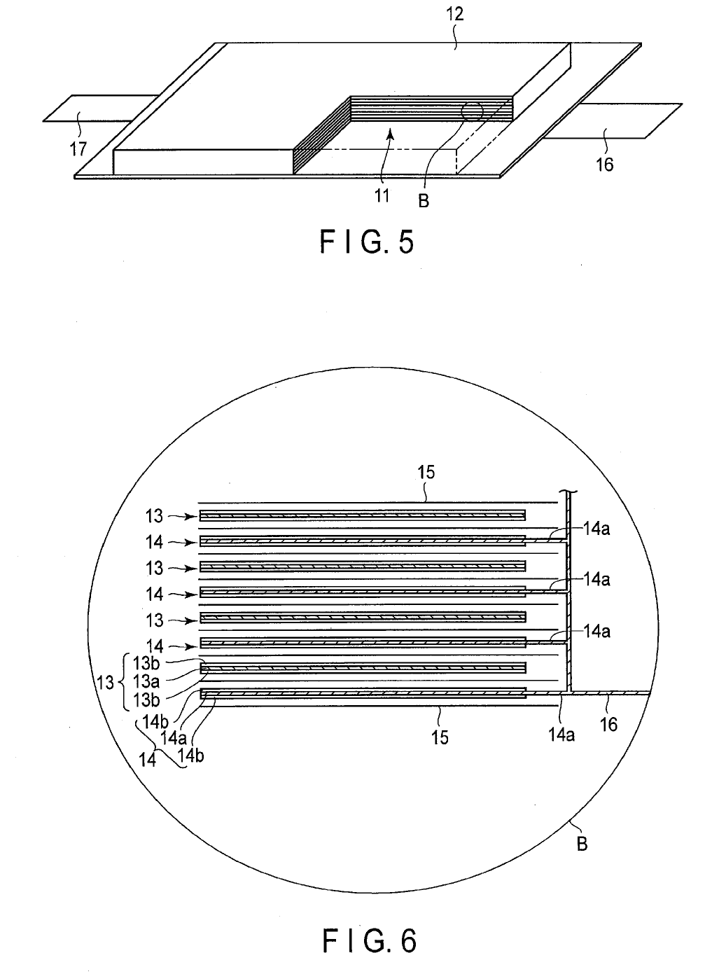

The nonaqueous electrolyte battery according to the second embodiment is not limited to the configuration shown in FIGS. 2 and 3 described above. For example, the battery may be configured as shown in FIGS. 5 and 6. FIG. 5 is a partially cut-out perspective view schematically showing another flat-form nonaqueous electrolyte secondary battery according to the second embodiment. FIG. 6 is an enlarged cross-sectional view showing a portion B in FIG. 5.

A stacked electrode group 11 is housed in the container member 12. The container member 12 is made of a laminate film where a metal layer is sandwiched between two resin films. As shown in FIG. 6, the stacked electrode group 11 has a structure in which positive electrodes 13 and negative electrodes 14 are alternately stacked with a separator 15 sandwiched therebetween. The electrode group 11 includes plural positive electrodes 13. Each of the plural positive electrodes 13 includes a positive electrode current collector 13a, and a positive electrode layer 13b supported on both of reverse surfaces of the positive electrode current collector 13a. The electrode group 11 includes plural negative electrodes 14. Each of the plural negative electrodes 14 includes a negative electrode current collector 14a, and a negative electrode layer 14b supported on both of reverse surfaces of the negative electrode current collector 14a. An end of the negative electrode current collector 14a of each of the negative electrodes 14 protrudes out from the negative electrode 14. The protruded negative electrode current collector 14a is electrically connected to a strip-shaped negative electrode terminal 16. The tip of the strip-shaped negative electrode terminal 16 is extended out from the container member 12. Although not shown in the drawings, an end of the positive electrode current collector 13a of the positive electrode 13 protrudes from the positive electrode 13 at the side opposed to the protruded end of the negative electrode current collector 14a. The positive electrode current collector 13a protruding from the positive electrode 13 is electrically connected to a strip-shaped positive electrode terminal 17. The tip of the strip-shaped positive electrode terminal 17 is positioned on the opposite side from the negative electrode terminal 16, and extended out from a side of the container member 12.

According to the above described second embodiment, there can be provided a nonaqueous electrolyte battery exhibiting excellent rapid charge-and-discharge performance, having high energy density, and exhibiting long life.

### Third Embodiment

Next, an example of a battery pack according to the third embodiment will be described with reference to the drawings. The battery pack includes one or plural of the nonaqueous electrolyte battery (unit cell) according to the second embodiment described above. When plural unit cells are included, each of the unit cells are arranged so as to be electrically connected in series or in parallel. The plural unit cells may also be connected in a combination of in a series and in parallel. The plural nonaqueous electrolyte batteries can be electrically connected to structure a battery module. The battery pack according to the third embodiment may include plural battery modules.

The battery pack according to the third embodiment may further include a protective circuit. The protective circuit has a function to control charging and discharging of the nonaqueous electrolyte battery. Alternatively, a circuit included in an equipment where the battery pack serves as a power source (for example, electronic devices, vehicles, and the like) may be used as the protective circuit for the battery pack.

Moreover, the battery pack according to the third embodiment may further comprise an external power distribution terminal. The external power distribution terminal is configured to externally output current from the nonaqueous electrolyte battery, and to input current to the nonaqueous electrolyte battery. In other words, when the battery pack is used as a power source, the current is externally provided via the external power distribution terminal. When the battery pack is charged, the charging current (including regenerative energy caused by power of vehicles such as automobiles) is provided to the battery pack via the external power distribution terminal.

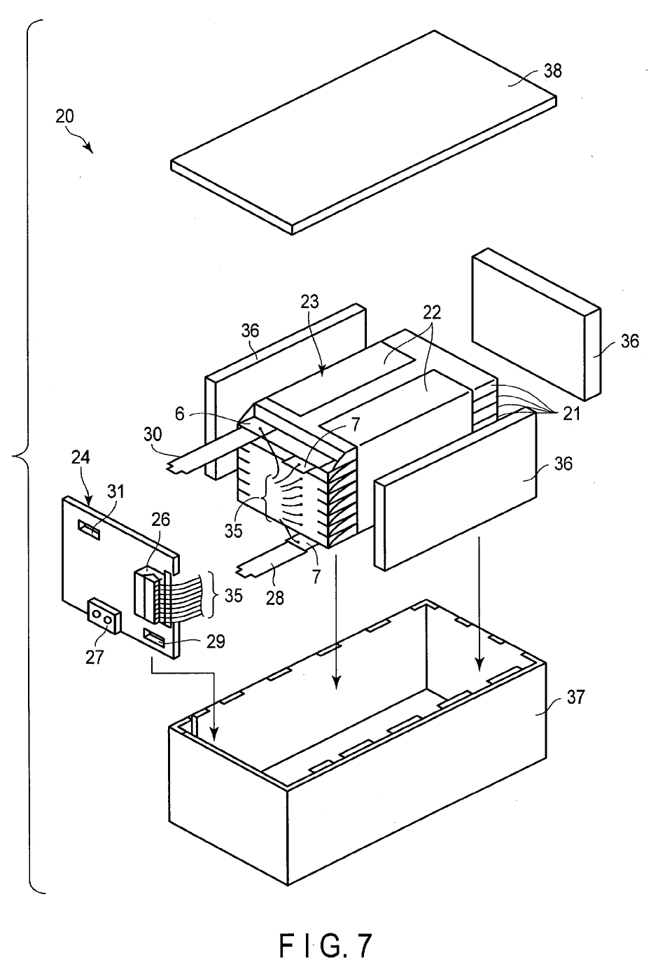

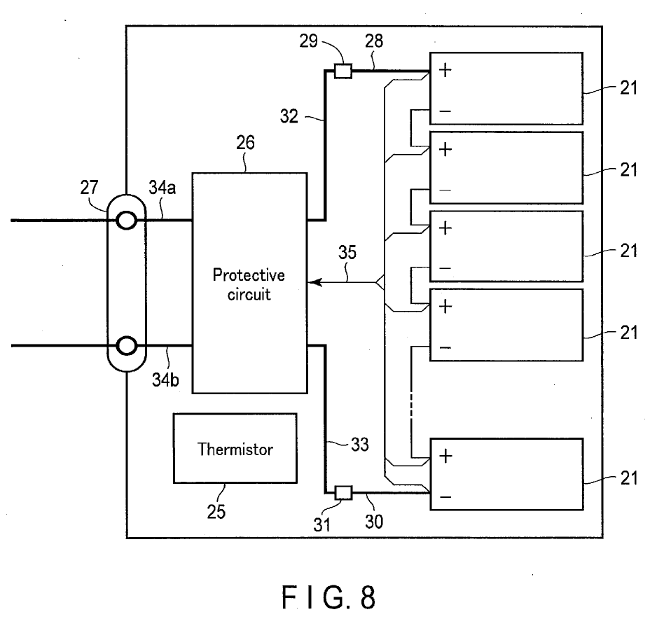

One example of a battery pack 20 is shown in FIGS. 7 and 8. This battery pack 20 includes plural flat-form batteries 21 having the configuration shown in FIG. 3. FIG. 7 is an exploded perspective view of an example of the battery pack 20. FIG. 8 is a block diagram showing an electric circuit of the battery pack 20 of FIG. 7.

Plural unit cells 21 are stacked so that the negative electrode terminals 6 and the positive electrode terminals 7 extended outside are arranged in the same direction, and fastened with an adhesive tape 22 to configure a battery module 23. The unit cells 21 are electrically connected in series as shown in FIG. 8.

A printed wiring board 24 is arranged to face opposite to the side plane where the negative electrode terminal 6 and the positive electrode terminal 7 of the unit cell 21 extend out from. A thermistor 25, a protective circuit 26, and an energizing terminal 27 to an external device, which serves as an external power distribution terminal, are mounted on the printed wiring board 24 as shown in FIG. 8. An electric insulating plate (not shown) is attached to the surface of the printed wiring board 24 facing the battery module 23 to avoid unnecessary connection of the wires of the battery module 23.

A positive electrode-side lead 28 is connected to the positive electrode terminal 7 located at the bottom layer of the battery module 23 and the distal end of the lead 28 is inserted into a positive electrode-side connector 29 of the printed wiring board 24 so as to be electrically connected. A negative electrode-side lead 30 is connected to the negative electrode terminal 6 located at the top layer of the battery module 23 and the distal end of the lead 30 is inserted into an negative electrode-side connector 31 of the printed wiring board 24 so as to be electrically connected. The connectors 29 and 31 are connected to the protective circuit 26 through wires 32 and 33 formed on the printed wiring board 24.

The thermistor 25 detects the temperature of the unit cells 21, and the detection signal is sent to the protective circuit 26. The protective circuit 26 can shut down a plus-side wire 34a and a minus-side wire 34b between the protective circuit 26 and the energizing terminal 27 to an external device, serving as an external power distribution terminal, under a predetermined condition. The predetermined condition indicates, for example, the case where the temperature detected by the thermistor 25 becomes a predetermined temperature or more. Another example of the predetermined condition is when the over-charge, over-discharge, or over-current of the unit cells 21 is detected. The detection of the over-charge and the like is performed on each of the unit cells 21 or the whole of the unit cells 21. When each of the unit cells 21 is detected, the cell voltage may be detected, or positive electrode or negative electrode potential may be detected. In the latter case, a lithium electrode to be used as a reference electrode is inserted into each of the unit cells 21. In the case of FIGS. 7 and 8, wires 35 for voltage detection are connected to each of the unit cells 21. Detection signals are sent to the protective circuit 26 through the wires 35.

Protective sheets 36 made of rubber or resin are arranged on three side planes of the battery module 23 except the side plane from which the positive electrode terminal 7 and the negative electrode terminal 6 protrude out from.

The battery module 23 is housed in a housing container 37 together with each of the protective sheets 36 and the printed wiring board 24. That is, the protective sheets 36 are arranged on both internal surfaces in a long side direction and on one internal surface in a short side direction of the housing container 37. The printed wiring board 24 is arranged on the internal surface on the opposite side in a short side direction. The battery module 23 is located in a space surrounded by the protective sheets 36 and the printed wiring board 24. A lid 38 is attached to the upper surface of the housing container 37.

In order to fix the battery module 23, a heat-shrinkable tape may be used in place of the adhesive tape 22. In this case, the battery module is bound by placing the protective sheets on the both sides of the battery module, revolving the heat-shrinkable tape, and thermally shrinking the heat-shrinkable tape.

In FIGS. 7 and 8, an embodiment has been shown where unit cells 21 are connected in series; however, the connection may be made in parallel in order to increase battery capacity. Alternatively, connection in series may be combined with connection in parallel. Assembled battery packs may be connected further in series or in parallel.

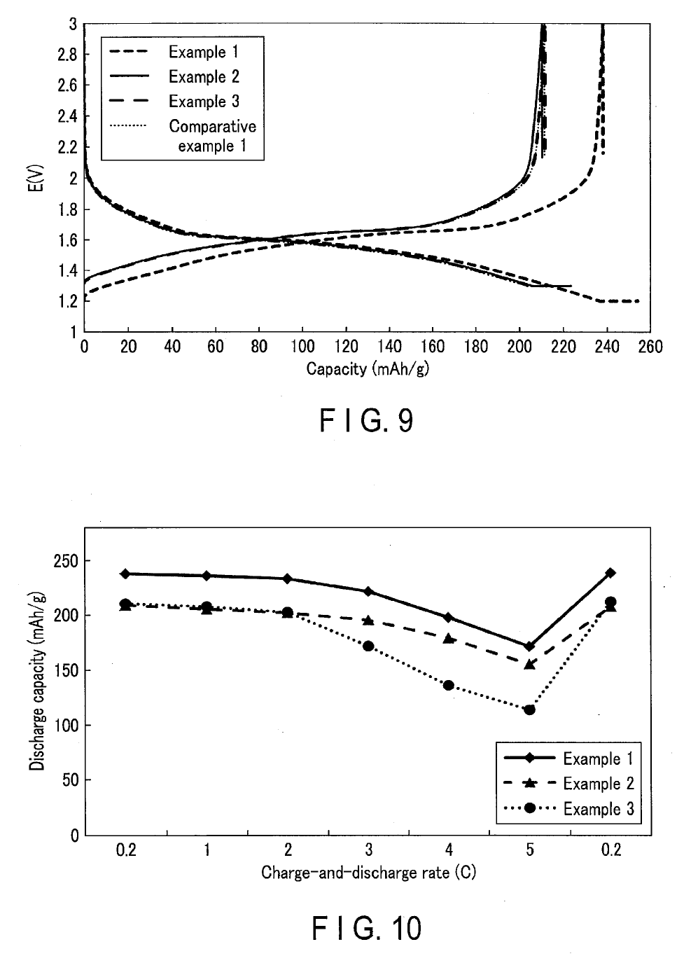

Furthermore, although the battery pack shown in FIGS. 7 and 9 include plural unit cells 21, the battery pack according to the third embodiment may include only one unit cell 21.

The aspect of the battery pack may be appropriately changed depending on its application. The battery pack according to the embodiment can be suitably used in applications in which cycle performance is demanded to be excellent when large current is taken out. Specifically the battery pack is used as a power source of a digital camera, or for example, a battery for mounting on a vehicle such as a two- to four-wheeled hybrid electric automobiles, a two- to four-wheeled electric automobiles or a power-assisted bicycle. In particular, the battery pack is suitably used for a battery mounted on a vehicle.

In a vehicle to which the battery pack according to the third embodiment has been mounted, the battery pack is configured, for example, to recover regenerative energy caused by power of the vehicle. Examples of the vehicle include two to four-wheeled hybrid electric automobiles, two to four-wheeled electric automobiles, electric assist bicycles, and electric trains.

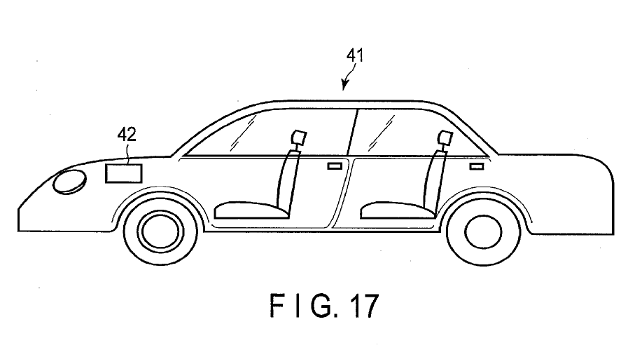

FIG. 17 shows an example of an automobile that includes a battery pack according to the third embodiment.

The automobile 41 shown in FIG. 17 includes a battery pack 42, which is an example of the battery pack according to the third embodiment, mounted in its engine room. The mounting position is not limited to engine rooms. For example, the battery pack may also be mounted in rear parts of automobiles or under seats.

According to the above described third embodiment, there can be provided a battery pack exhibiting excellent rapid charge-and-discharge performance, having high energy density, and exhibiting long life.

### EXAMPLES

The embodiments described above are explained in more detailed by means of Examples.

### Example 1

### Manufacture of Electrode

Commercially available oxide reagents Nb₂O₅ powder and TiO₂ powder were each weighed so that a molar ratio of niobium to titanium was 2. The powders were mixed in a mortar. The mixture was put in an electric furnace and was calcined at 1150° C. for 20 hours in total. Thereby, a niobium-titanium composite oxide TiNb₂O₇ was obtained.

Identification of a crystal phase and estimation of a crystal structure of the synthesized niobium-titanium composite oxide were performed by a powder X-ray diffractometry using Cu-Kα rays. A composition of the product was analyzed by ICP (inductively coupled plasma) method, and it was confirmed that a desired product was obtained. A TEM (transmission electron microscopy) observation and an EPMA (electron probe microanalyzer) measurement were performed to examine a state of the element M. In addition, a DSC (differential scanning calorimetry) measurement of the obtained sample was performed, and a melting point was investigated from the endothermic peak point position.

As the electrode active material, the niobium-titanium composite oxide synthesized as above was mixed with VGCF (registered trademark: Vapor Grown Carbon Fiber) as the conductive agent. The mixing ratio thereof was adjusted to 10 parts by weight of VGCF based on 100 parts by weight of the composite oxide. The mixture was dispersed in N-methyl-2-pyrrolidone (NMP). By mixing into the obtained dispersion 10 parts by weight of PVdF as a binder, an electrode slurry was manufactured. The slurry was coated onto both of reverse surfaces of a current collector made of an aluminum foil using a blade. Thereafter, the slurry on the current collector was dried at 130° C. for 12 hours under vacuum to obtain an electrode.

(Preparation of Electrolytic Solution)

Ethylene carbonate and diethyl carbonate were mixed in a volume ratio of 2:1 to prepare a mixed solvent. Into the mixed solvent was dissolved lithium hexafluoro phosphate in a concentration of 1 M to prepare a nonaqueous electrolyte. Into the prepared nonaqueous electrolyte was dissolved tris(trimethylsilyl)phosphate (TMSP) as an additive, in a proportion of 1% by weight relative to the nonaqueous electrolyte, to obtain an electrolytic solution.

(Manufacture of Electrochemical Measurement Cell)

Using the electrode produced as described above, a metallic lithium foil as a counter electrode, and the electrolytic solution prepared as described above, an electrochemical measurement cell was manufactured.

### Example 2

An electrolytic solution was obtained by dissolving, relative to the nonaqueous electrolyte, 0.5% by weight of hexamethylene diisocyanate (HDI) and 1% by weight of TMSP in the nonaqueous electrolyte as the additive, instead of TMSP alone. An electrochemical measurement cell was produced in the same manner as in Example 1, except that the resulting electrolytic solution was used. The obtained cell was used as an electrochemical measurement cell of Example 2.

### Example 3

An electrolytic solution was obtained by dissolving, relative to the nonaqueous electrolyte, 1% by weight of lithium difluorophosphate (LiPF₂O₂) as the additive, instead of TMSP. An electrochemical measurement cell was produced in the same manner as in Example 1, except that the resulting electrolytic solution was used. The obtained cell was used as an electrochemical measurement cell of Example 3.

### Comparative Example 1

An electrochemical measurement cell was produced in the same manner as in Example 1, except that TMSP was not added, and an additive-free nonaqueous electrolyte was used for the electrolytic solution. The obtained cell was used as an electrochemical measurement cell of Comparative Example 1.

### Example 4

### Production of Negative Electrode

An electrode was produced in the same manner as in Example 1, and used as a negative electrode.

(Production of Positive Electrode)

As a positive electrode active material, LiMn_{0.8}Fe_{0.2}PO₄ was synthesized by a hydrothermal method as described below.

Lithium carbonate as an Li-including compound, manganese (II) sulfate pentahydrate (MnSO₄.5H₂O) as an Mn-including compound, and iron (II) sulfate heptahydrate (FeSO₄.7H₂O) as an Fe-including compound were used. Furthermore, carboxymethyl cellulose (CMC) was used as a C-including compound. These starting materials were dissolved in pure water and mixed in a nitrogen atmosphere. Here the starting materials were mixed in a mixing ratio where a molar ratio of the metals in the starting materials was Li:Mn:Fe=3:0.8:0.2. The above mixing ratio was adopted since it is preferable to use Li in an amount of the stoichiometric ratio or more because impurities having lithium defects are easily produced when synthesizing LiMn_{0.8}Fe_{0.2}PO₄.

Next, the solution, which was obtained by dissolving and mixing the starting materials as described above, was put in a pressure resistant vessel, which was sealed, and a heat-treatment was performed at 200° C. for 3 hours while the mixture was stirred to obtain a suspension including synthesized powder. After the heat-treatment, the synthesized powder was extracted from the solution by centrifugal separation. Furthermore, in order to prevent aggregation of the extracted, synthesized powder, the synthesized powder was freeze-dried after the extraction, and then the synthesized powder was collected.

The obtained synthesized powder was subjected to heat-treatment at 700° C. for one hour under an argon atmosphere to obtain the target product, LiMn_{0.8}Fe_{0.2}PO₄, which is the positive electrode active material.

LiMn_{0.8}Fe_{0.2}PO₄ as the positive electrode active material and acetylene black as the conductive agent were mixed. The mixing ratio was adjusted to 90:5. The mixture was dispersed in N-methyl-2-pyrrolidone (NMP) to obtain a dispersion. Relative to 100 parts by weight of the active material, 5 parts by weight of polyvinylidene fluoride (PVdF) as the binder was mixed into the obtained dispersion to manufacture a positive electrode slurry. The slurry was coated on both of reverse surfaces of an aluminum current collector using a blade. After that, the slurry on the current collector was dried at 130° C. for 8 hour or more under vacuum to obtain a positive electrode.

(Manufacture of Electrode Group)

A separator formed of a polyethylene porous film having a thickness of 25 μm was used as a separator.

The negative electrode, the separator, the positive electrode, and another separator, which had been obtained as described above, were laminated in this order to obtain a stack. Next, the stack was spirally wound such that the negative electrode was positioned as the outermost layer. The wound stack was hot-pressed at 80° C. to produce a flat electrode group. The obtained electrode group was housed in a pack formed of a laminate film having a three-layer structure of nylon layer/aluminum layer/polyethylene layer and having a thickness of 2 mm, and was dried at 80° C. for 8 hours or more under vacuum.

(Manufacture of Electrolytic Solution)

An electrolytic solution was prepared in the same manner as in the preparation of the electrolytic solution in Example 3.

(Manufacture of Nonaqueous Electrolyte Battery)

The electrolytic solution was poured into the laminate film pack, in which the electrode group was housed as described above, and then the pack was completely sealed by heat-sealing. Thereby, a laminate cell (a flat-type nonaqueous electrolyte battery) was obtained.

### Example 5

An electrolytic solution was obtained by dissolving, relative to the nonaqueous electrolyte 1% by weight of TMSP in the nonaqueous electrolyte as an additive, instead of LiPF₂O₂. A laminate cell was produced in the same manner as in Example 4, except that the resulting electrolytic solution was used. The obtained cell was used as a laminate cell of Example 5.

### Example 6

An electrolytic solution was obtained by dissolving, relative to the nonaqueous electrolyte 1% by weight of TMSP and 1% by weight of HDI in the nonaqueous electrolyte as additives, instead of LiPF₂O₂. A laminate cell was produced in the same manner as in Example 4 except that the resulting electrolytic solution was used. The obtained cell was used as a laminate cell of Example 6.

### Example 7

An electrolytic solution was obtained by dissolving, relative to the nonaqueous electrolyte 1% by weight of HDI and 1% by weight of LiPF₂O₂ in the nonaqueous electrolyte as additives, instead of LiPF₂O₂ alone. A laminate cell was produced in the same manner as in Example 4 except that the resulting electrolytic solution was used. The obtained cell was used as a laminate cell of Example 7.

### Example 8

An electrolytic solution was obtained by dissolving LiPF₂O₂ in the nonaqueous electrolyte with the additive amount changed to 5% by weight relative to the nonaqueous electrolyte. A laminate cell was produced in the same manner as in Example 4 except that the resulting electrolytic solution was used. The obtained cell was used as a laminate cell of Example 8.

### Comparative Example 2

Commercially available oxide reagents TiO₂ powder and LiCO₃ powder were each weighed such that a molar ratio of lithium:titanium:oxygen would be 4:5:12, and mixed in a mortar. The mixture was put in an electric furnace and was calcined at 900° C. for 20 hours in total. Thereby, a lithium-titanium oxide Li₄Ti₅O₁₂ (LTO) was obtained.

As the negative electrode active material, LTO obtained above was mixed with flake graphite as a conductive agent in a mixing ratio of 100:10. The resulting mixture was dispersed in NMP to obtain a dispersion. By mixing into the obtained dispersion, PVdF as a binder in an amount of 2 parts by weight, based on 100 parts by weight of the negative electrode active material, a negative electrode slurry was obtained. The slurry was coated on both of reverse surfaces of an aluminum current collector using a blade. After that, slurry on the current collector was dried at 130° C. for 12 hours under vacuum to obtain a negative electrode.

A laminate cell was produced in the same manner as in Example 4, except that the negative electrode obtained above was used. The obtained cell was used as a laminate cell of Comparative Example 2.

### Comparative Example 3

A laminate cell was produced in the same manner as in Comparative Example 2, except that the additive (LiPF₂O₂) was not added, and an additive-free nonaqueous electrolyte was used for the electrolytic solution. The obtained cell was used as a laminate cell of Comparative Example 3.

(Electrochemical Measurement)

For Examples 1 to 3, rate performances of the manufactured electrochemical measurement cells were investigated as follows. A discharge capacity of each electrochemical measurement cell was measured at a discharge rate of 0.2 C, 1 C, 2 C, and 5 C (a time discharge rate) under a temperature condition of 25° C. In addition, a ratio of a discharge capacity at 1 C, 2 C, or 5 C to a discharge capacity at 0.2 C was calculated, wherein the discharge capacity obtained at a discharge rate of 0.2 C was assumed as 1.0. The potential range for the charge-and-discharge was set to 1.2 V to 3.0 V, relative to the metal lithium electrode as standard, for the electrochemical measurement cell of Example 1, and set to 1.3 V to 3.0 V for Examples 2 and 3.

Next, for the electrochemical measurement cells of Examples 1 to 3 and Comparative Example 1, a repeated charge-and-discharge cycle test, in which one cycle of charge-and-discharge at a charge-and-discharge current of 1 C rate under a temperature condition of 45° C. was repeated 40 cycles, was performed to investigate a 40-cycle charge-and-discharge capacity retention ratio. Specifically, assuming a 1 C discharge capacity at the first cycle to be 100%, a ratio of a 1 C discharge capacity at the 40th cycle to the 1 C discharge capacity at the first cycle was calculated to obtain a discharge capacity retention ratio (%) after the cycle test.

In the cycle test, the charge-and-discharge in each cycle was performed within a potential range of 1.2 V to 3.0 V, relative to the metallic lithium electrode as standard, for the electrochemical measurement cell of Example 1, within a potential range of 1.3 V to 3.0 V for Examples 2 and 3, and within a potential range of 1.3 V to 3.0 V for Comparative Example 1.

For the laminate cells of Example 4 and Comparative Examples 2 and 3, a repeated charge-and-discharge test, in which one cycle of charge-and-discharge at a charge-and-discharge current value of 1 C rate in a temperature condition of 60° C. was repeated 100 cycles, was performed to investigate a 100-cycle charge-and-discharge capacity retention ratio. Specifically, assuming a 1 C discharge capacity at the first cycle to be 100%, a ratio of a 1 C discharge capacity at the 100th cycle to a 1 C discharge capacity at the first cycle was calculated to obtain a capacity retention ratio (%) after the cycle test.

In the cycle performance test, the charge-and-discharge in each cycle was performed within a potential range of 2.85 V to 1.5 V for the laminate cell of Example 4, and within a range of 2.7 V to 1.5 V for the laminate cell of Comparative Examples 2 and 3.

Furthermore, for the laminate cells of Examples 5 to 8, a repeated charge-and-discharge test, in which one cycle of charge-and-discharge at a charge-and-discharge current value of 1 C rate under a temperature condition of 45° C. was repeated 100 cycles, was performed to investigate a 100-cycle charge-and-discharge capacity retention ratio. Specifically, assuming that a 1 C discharge capacity at the first cycle to be 100%, a ratio of a 1 C discharge capacity at the 100th cycle to a 1 C discharge capacity at the first cycle was calculated to obtain a capacity retention ratio (%) after the cycle test.

In the cycle test, the charge-and-discharge in each cycle was performed within a potential range of 2.85 V to 1.5 V for the laminate cells of Examples 5 to 8.

### (X-Ray Photoelectron Spectroscopy (XPS))

For the electrodes in the electrochemical measurement cells of Examples 1 to 3 and Comparative Example 1, and the negative electrodes in the laminate cells of Examples 4 to 8 and Comparative Examples 2 and 3, XPS measurement was performed as described above.

FIG. 9 is a graph showing the initial charge-and-discharge curves of the electrochemical measurement cells of Examples 1 to 3 and Comparative Example 1 (charge-and-discharge rate: 0.2 C). As apparent from FIG. 9, there is no meaningful difference between the charge-and-discharge curves of the electrochemical measurement cells of Examples 2 and 3 and Comparative Example 1. The charge-and-discharge curve of the electrochemical cell of Example 1 is at a position slightly deviated from the charge-and-discharge curves of Examples 2 and 3 and Comparative Example 1. It can be considered that this is due to the potential range in the charge-and-discharge for the former having been from 1.2 V to 3.0 V, whereas the potential range for the latter was from 1.3 V to 3.0 V.

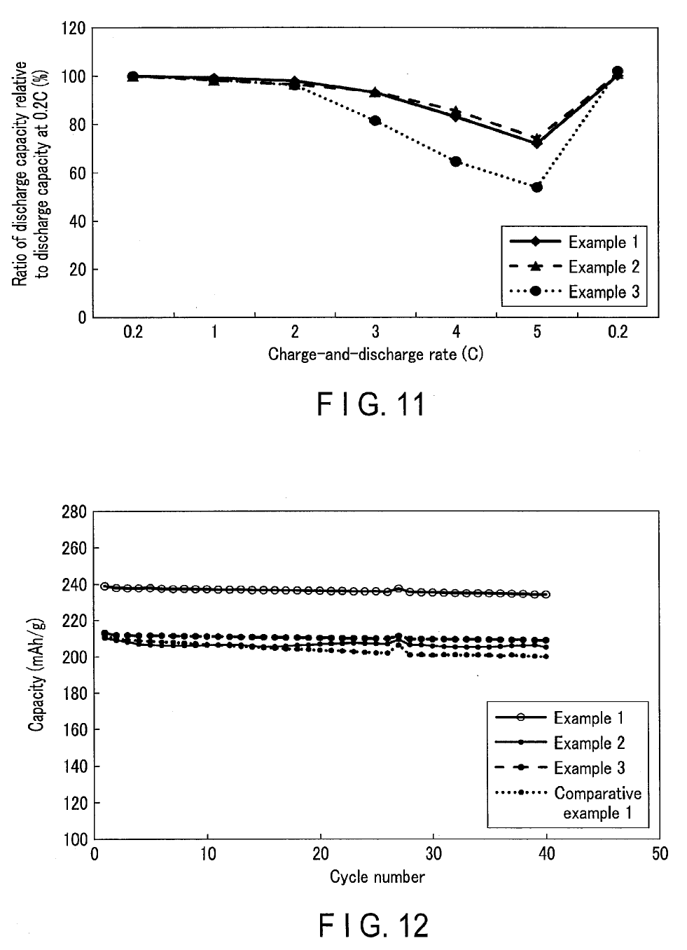

FIG. 10 and FIG. 11 are graphs showing the rate performances of the electrochemical measurement cells of Examples 1 to 3. Specifically, FIG. 10 shows the variation in the discharge capacity per charge-and-discharge rate for the electrochemical measurement cells of Examples 1 to 3. FIG. 11 shows the discharge capacity ratio per charge-and-discharge rate, calculated based on the discharge capacity at the 0.2 C rate. As apparent from FIG. 10 and FIG. 11, the electrochemical measurement cells of Examples 1 and 2 in which TMSP was added to the electrolytic solution showed more excellent rate performance than that in Example 3 in which TMSP was not added.

FIG. 12 is a graph showing the capacity variation per cycle of the electrochemical measurement cells of Examples 1 to 3 and Comparative Example 1. As apparent from FIG. 12, in the electrochemical measurement cells of Examples 1 to 3, the discharge capacity had hardly decreased up to the 40th cycle, exhibiting good capacity retention ratio. On the other hand, in the electrochemical measurement cell of Comparative Example 1, the discharge capacity had gradually decreased from the initial stage of the cycle test.

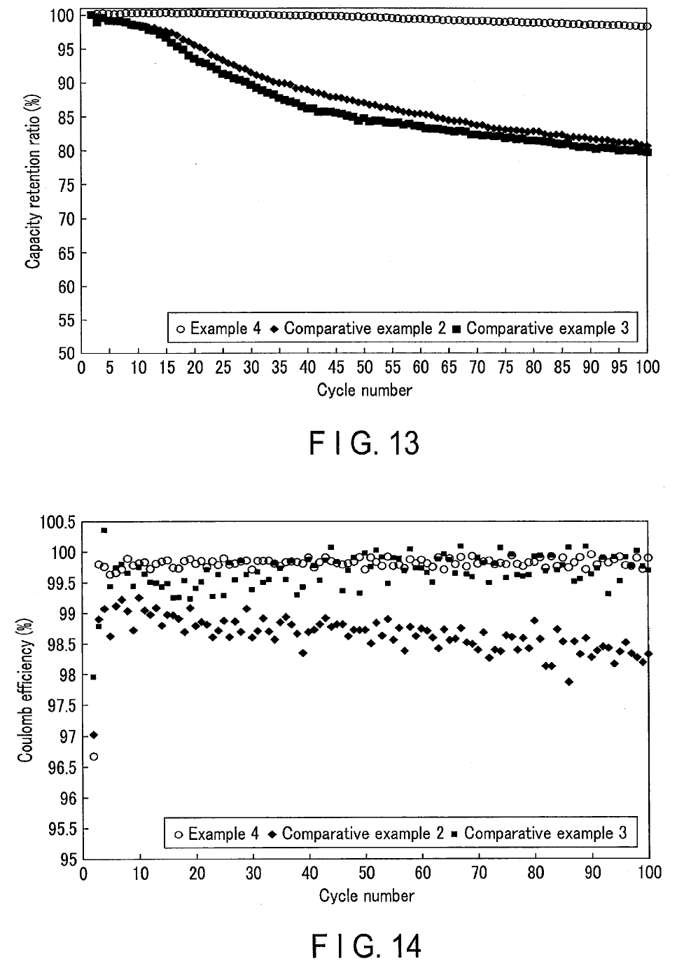

FIG. 13 is a graph showing the variation in the capacity of the laminate cell per charge-and-discharge cycle for Example 4 and Comparative Examples 2 and 3. From FIG. 13, it can be seen that in the laminate cell of Example 4, the high capacity retention ratio could be maintained up to the 100th cycle. As opposed to this, it can be seen from FIG. 13 that in the laminate cells of Comparative Examples 2 and 3, the capacity retention ratio had gradually decreased from the initial stage of the cycle test. In particular, in the laminate cells of Comparative Examples 2 and 3, the capacity retention ratio had rapidly decreased from the 15th to 20th cycle.

FIG. 14 is a graph showing the coulomb efficiency of the laminate cell per charge-and-discharge cycle for Example 4 and Comparative Examples 2 and 3. From FIG. 14, it can be seen that the coulomb efficiency of the laminate cell of Comparative Example 2 is lower than those of the laminate cells of Example 4 and Comparative Example 3. In addition, while in the laminate cells of Example 4 and Comparative Example 3, there is almost no variation in the coulomb efficiency per cycle, and in the laminate cell of Comparative Example 2, the coulomb efficiency tended to decrease as cycles were repeated.

As described above, in the laminate cell in which an oxide of titanium such as LTO was used as the negative electrode active material, the influence due to addition of the additive to the electrolytic solution on the cycle performance was poor, and the coulomb efficiency degraded due to addition of the additive.

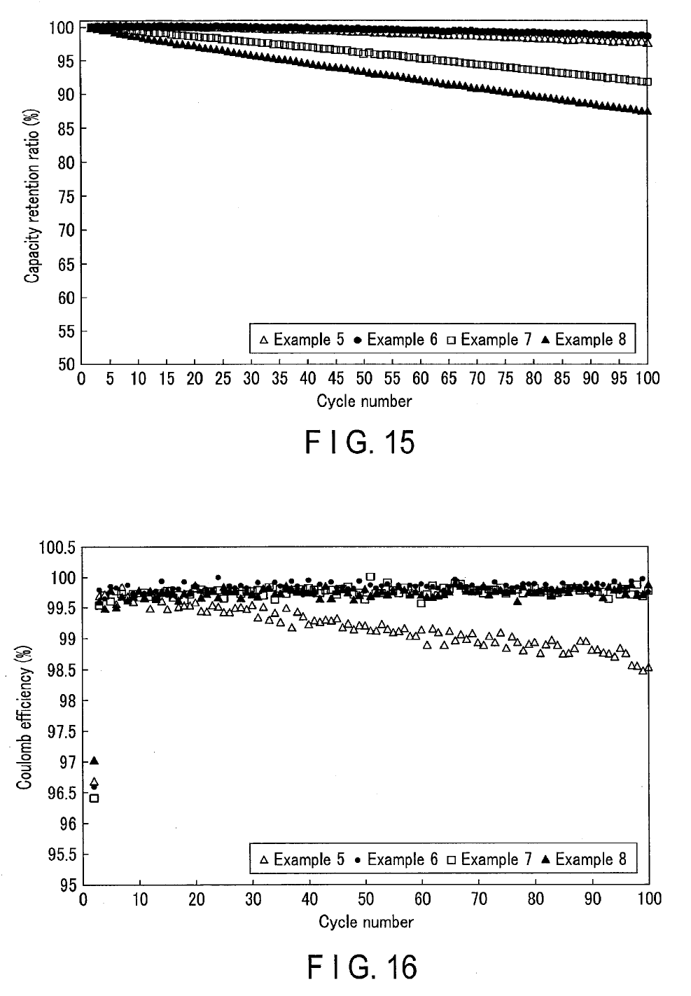

FIG. 15 is a graph showing the variation in the capacity of the laminate cell per charge-and-discharge cycle for the laminate cells of Examples 5 to 8. From FIG. 15, it can be seen that all of the laminate cells of Examples 5 to 8 had maintained the high capacity retention ratio up to the 100th cycle.

FIG. 16 is a graph showing the coulomb efficiency of the laminate cell per charge-and-discharge cycle for the laminate cells of Examples 5 to 8. From FIG. 16, it can be seen that in all of the laminate cells of Examples 5 to 8, there is almost no variation in the coulomb efficiency per cycle.

The XPS measurement results for the electrodes in the electrochemical cells of Examples 1 to 3 and Comparative Example 1 are shown in Table 1. The surface composition ratio (Li+C+O)/P of the electrode, calculated based on the measurement results, are also shown in Table 1.

TABLE 1

| | Li | C | O | F | Si | P | Ti | Nb | |
|---|---|---|---|---|---|---|---|---|---|
| | (1s) | (1s) | (1s) | (1s) | (2p) | (2p) | (2p) | (3d) | (Li + C + O)/P |
| Example 1 | 10.1 | 34 | 29 | 15 | 0.41 | 7 | — | 0.05 | 10.44 |
| Example 2 | 9.5 | 32 | 31 | 14.3 | 0.53 | 8 | — | 0.02 | 9.1 |
| Example 3 | 22 | 20 | 25 | 26 | 0.26 | 6.3 | 0.07 | 0.17 | 10.6 |
| Comparative | 26 | 21 | 19.2 | 29 | 3.6 | 3.6 | 0.09 | 0.18 | 18.4 |
| Example 1 | | | | | | | | | |

As shown in Table 1, the surface composition ratios (Li+C+O)/P of the electrodes of Examples 1 to 3 were within a range of 2 to 14. On the other hand, the surface composition ratio (Li+C+O)/P of the electrode of Comparative Example 1, in which the additive was not added to the electrolytic solution, was more than 14.

The XPS measurement results for the negative electrodes of the laminate cells of Examples 4 to 8 and Comparative Examples 2 and 3 are shown in Table 2. The surface composition ratio (Li+C+O)/P of the electrodes (negative electrodes), calculated based on the measurement results, are also shown in Table 2.

TABLE 2

| | Li | C | O | F | Si | P | Ti | Nb | (LI + C + O)/ |
|---|---|---|---|---|---|---|---|---|---|
| | (1s) | (1s) | (1s) | (1s) | (2p) | (2p) | (2p) | (3d) | P |
| Example 4 | 21 | 22 | 26 | 25 | 0.02 | 7 | 0.01 | 0.15 | 9.85 |
| Example 5 | 9.5 | 17 | 23 | 32 | 0.33 | 11 | — | 0.03 | 4.5 |
| Example 6 | 9.3 | 30 | 29.5 | 16 | 0.3 | 11.47 | — | 0.04 | 6 |
| Example 7 | 20 | 24 | 30 | 22.1 | 0.34 | 5.4 | — | 0.03 | 13.65 |
| Example 8 | 20 | 13 | 17 | 29 | 3.2 | 15.6 | — | 0.02 | 3.2 |
| Comparative | 28 | 26 | 23.7 | 20 | — | 5 | 0.02 | 0.05 | 15.54 |
| Example 2 | | | | | | | | | |
| Comparative | 27 | 19 | 24.2 | 26 | — | 3.9 | — | — | 18 |
| Example 3 | | | | | | | | | |

As shown in Table 2, the surface composition ratios (Li+C+O)/P of the negative electrodes of Examples 4 to 8 were within a range of 2 to 14. On the other hand, the surface composition ratios (Li+C+O)/P of the negative electrode of Comparative Examples 2 and 3, in which LTO was included as the active material, were more than 14.

In Table 3, for the electrochemical measurement cells of Examples 1 to 3 and Comparative Example 1, and the laminate cells of Examples 4 to 8 and Comparative Examples 2 and 3, the electrode active material used in each electrode (negative electrode), the additive which was added to the electrolytic solution, the surface composition ratio (Li+C+O)/P of each electrode (negative electrode) calculated from the results of Table 1 and Table 2, the temperature condition in the cycle test, the number of cycles carried out in the cycle test, and the capacity retention ratio after the cycle test are summarized.

TABLE 3

| | | | | | | Capacity |
|---|---|---|---|---|---|---|
| | | | | | | Maintenance |
| | | Additive to | | Temperature | | Ratio |
| | Electrode | Electrolytic | | Condition of | Number | After |
| | Active | Liquid | (Li + C + O)/ | Cycle Test | of | Cycle Test |
| | Material | (added amount) | P | (° C.) | Cycles | (%) |
| Example 1 | TiNb₂O₇ | TMSP (1 wt %) | 10.44 | 45 | 40 | 98.02 |
| Example 2 | TiNb₂O₇ | HDI (0.5 wt %) + | 9.1 | 45 | 40 | 97.0 |
| | | TMSP (1 wt %) | | | | |
| Example 3 | TiNb₂O₇ | LiPF₂O₂ (1 wt %) | 10.6 | 45 | 40 | 98.03 |
| Comparative | TiNb₂O₇ | none | 18.4 | 45 | 40 | 94.5 |
| Example 1 | | | | | | |
| Example 4 | TiNb₂O₇ | LiPF₂O₂ (1 wt %) | 9.85 | 60 | 100 | 98.32 |
| Example 5 | TiNb₂O₇ | TMSP (0.5 wt %) | 4.5 | 45 | 100 | 97.7 |
| Example 6 | TiNb₂O₇ | TMSP (1 wt %) + | 6 | 45 | 100 | 98.8 |
| | | HDI (1 wt %) | | | | |
| Example 7 | TiNb₂O₇ | HDI (1.0 wt %) + | 13.65 | 45 | 100 | 92.03 |
| | | LiPF₂O₂ (1%) | | | | |
| Example 8 | TiNb₂O₇ | LiPF₂O₂ (5 wt %) | 3.2 | 45 | 100 | 87.86 |
| Comparative | Li₄Ti₅O₁₂ | LiPF₂O2 (1 wt %) | 15.54 | 60 | 100 | 80.05 |
| Example 2 | | | | | | |
| Comparative | Li₄Ti₅O₁₂ | none | 18 | 60 | 100 | 81.28 |
| Example 3 | | | | | | |

As apparent from Table 3, the electrochemical cells (Examples 1 to 3) including the electrode whose surface composition ratio (Li+C+O)/P is within a range of 2 to 14 show higher capacity retention ratio as compared to the electrochemical cell (Comparative Example 1) which does not include such an electrode.

From Table 3, it is also apparent that the laminate cell (Example 4), which includes the negative electrode whose surface composition ratio (Li+C+O)/P is within a range of 2 to 14, shows higher capacity retention ratio as compared to the laminate cells (Comparative Examples 2 and 3) which do not include such an electrode. In the cycle test performed for the laminate cells of Example 4 and Comparative Examples 2 and 3, in which the temperature condition was 60° C. and the number of cycles was 100, while the capacity retention ratio of the laminate cell of Example 4 was about 98% after 100 cycles, the capacity retention ratio of the laminate cells of Comparative Examples 2 and 3 were about 80% after 100 cycles.

Furthermore, from comparison of Examples 1 to 3, Examples 5 to 8, and Comparative Example 1, for which the cycle test was performed at a temperature condition of 45° C., in Table 3, it can be seen that in the case where the surface composition ratio (Li+C+O)/P of the electrode is within a range of 4 to 11, an even higher capacity retention ratio is exhibited as compared to the case where the surface composition ratio is outside this range. As shown in Table 3, in the battery cell in which the surface composition ratio of the electrode is from 4 to 11, the capacity retention ratio after the cycle test is 97% or more. As described above, when the surface composition ratio (Li+C+O)/P of the electrode is adjusted to 4 to 11, the cycle performance of the nonaqueous electrolyte battery becomes better, and is therefore more preferable.

An electrode of an embodiment includes an active material, and a surface composition ratio (Li+C+O)/P of the electrode, obtained by X-ray photoelectron spectroscopy (XPS) measurement, is within a range of 2 to 14. A nonaqueous electrolyte battery of another embodiment includes the electrode described above as a negative electrode. The nonaqueous electrolyte battery of the embodiment has high energy density, can stably perform rapid charge-and-discharge, and has good life performance.

While certain embodiments have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

1. An electrode comprising an active material, wherein a surface composition ratio (Li+C+O)/P of the electrode, as measured by an X-ray photoelectron spectroscopy (XPS), is within a range of 2 to 14.

2. The electrode according to claim 1, wherein the surface composition ratio (Li+C+O)/P is within a range of 4 to 11.

3. The electrode according to claim 1, wherein the electrode comprises a coating film on at least a part of a surface thereof, and the coating film includes phosphorous (P) and oxygen (O).

4. The electrode according to claim 1, wherein the active material comprises a coating film on at least a part of a surface thereof, and a composition ratio (Li+C+O)/P of the coating film, as measured by an X-ray photoelectron spectroscopy (XPS), is within a range of 2 to 14.

5. The electrode according to claim 4, wherein the composition ratio (Li+C+O)/P of the coating film is within a range of 4 to 11.

6. The electrode according to claim 1, wherein the active material comprises a niobium-titanium composite oxide.

7. The electrode according to claim 6, wherein the niobium-titanium composite oxide is represented by LiₓTiNb_{2-y}M_{y}O_{7±δ} where 0≦x≦5, 0≦y≦0.5, 0≦δ≦0.3, and M is at least one element selected from the group consisting of B, Na, Mg, Al, Si, S, P, K, Ca, Mo, W, Cr, Mn, Co, Ni, and Fe.

8. The electrode according to claim 6, wherein the niobium-titanium composite oxide is monoclinic composite oxide TiNb₂O₇.

9. A nonaqueous electrolyte battery comprising a negative electrode, a positive electrode, a separator, and a nonaqueous electrolyte, wherein the negative electrode is the electrode according to claim 1.

10. The nonaqueous electrolyte battery according to claim 9, wherein the positive electrode comprises a lithium-nickel composite oxide or a lithium-manganese composite oxide.

11. A battery pack comprising the nonaqueous electrolyte battery according to claim 9.

12. The battery pack according to claim 11, which further comprises a protective circuit and an external power distribution terminal.

13. The battery pack according to claim 11, wherein the battery pack comprises a plurality of the nonaqueous electrolyte batteries, wherein the nonaqueous electrolyte batteries are electrically connected in series, in parallel, or in a combination of in series and in parallel.

14. A vehicle onto which is mounted the battery pack according to claim 11.

15. The vehicle according to claim 14, wherein the battery pack is configured to recover a regenerative energy of a power of the vehicle.
